(19) United States
(12) Patent Application Publication
(10) Pub. No.: US 2020/0224630 A1
(43) Pub. Date: Jul. 16, 2020

(54) IGNITION COIL

(71) Applicant: BorgWarner Ludwigsburg GmbH, Ludwigsburg (DE)

(72) Inventors: Sven Schumm, Walheim (DE); Manfred Adolf, Schwaikheim (DE); Timo Stifel, Freiberg am Neckar (DE); Dirk Wüstenhagen, Auma (DE); Manuel Bauer, Ludwigsburg (DE); Alexander Stark, Althengstett (DE)

(21) Appl. No.: 16/741,349

(22) Filed: Jan. 13, 2020

(30) Foreign Application Priority Data
Jan. 15, 2019 (DE) 10 2019 100 894.8

(51) Int. Cl. F02P 13/00; H01F 38/12; H01T 13/06; H01T 13/05

(52) U.S. Cl. CPC F02P 13/00; H01T 13/05; H01T 13/06; H01F 38/12

(57) ABSTRACT

An ignition coil is described with a housing having a tubular housing part for connecting to a spark plug, and a pin-shaped interference suppression resistor arranged in the tubular housing part. According to this disclosure, it is provided that the housing surrounds an interior which has a funnel-shaped section which tapers toward the tubular housing part. In addition, a method is described for producing such an ignition coil.

### RELATED APPLICATIONS

This application claims priority to DE 10 2019 100 894.8, filed Jan. 15, 2019, the entire disclosure of which is hereby incorporated herein by reference.

### BACKGROUND

This disclosure relates to improvements of an ignition coil of the type generally known from DE 10 2017 116 277 A1 and associated methods of manufacturing.

Such ignition coils comprise a housing in which a transformer is arranged. The housing has a tubular section, which is designed as a plug for connecting the ignition coil to a spark plug. A pin-shaped interference suppression resistor, which is connected to the transformer, is arranged in the tubular housing part.

In the ignition coil known from DE 10 2017 116 277 A1, the interference suppression resistor is held by a plastic sleeve, which is inserted into the tubular housing part.

### SUMMARY

This disclosure teaches how an ignition coil may be manufactured at lower cost.

In an ignition coil according to this disclosure, the interior surrounded by the housing has a funnel-shaped section, which tapers towards the tubular housing part. In this way, the mounting of the pin-shaped interference suppression resistor in the tubular housing part is significantly simplified. Complex steps to align the pin-shaped interference suppression resistor are no longer necessary during assembly. It is sufficient to let the pin-shaped interference suppression resistor drop into the housing. Gravity causes the pin-shaped interference suppression resistor to arrive into the funnel-shaped housing part. After inserting the pin-shaped interference suppression resistor into the housing, the pin-shaped interference suppression resistor is thus advantageously pressed into the tubular housing part without requiring a previous complex positioning.

An advantageous refinement of this disclosure provides that a part of the funnel-shaped interior section is arranged in the tubular housing part. The housing may be advantageously compact in design because the funnel-shaped inner section projects into the tubular-shaped housing part.

Another advantageous refinement of this disclosure provides that the funnel-shaped interior section has an opening angle whose value decreases towards the tubular section. In other words, the funnel, formed by the interior section, becomes flatter at increasing distance from the interference suppression resistor. In this way, the funnel-shaped section of the housing interior may be formed with an advantageously low height and despite this can guarantee that an interference suppression resistor inserted into the interior is guided into the tubular housing part by the funnel-shaped interior section. Because the funnel-shaped interior section has an opening angle whose width decreases towards the tubular section, the housing may thus be designed to be advantageously compact.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an illustrative embodiment of an ignition coil according to this disclosure; and

FIG. 2 shows a schematic sectional view of a part of the housing with a pin-shaped interference suppression resistor.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

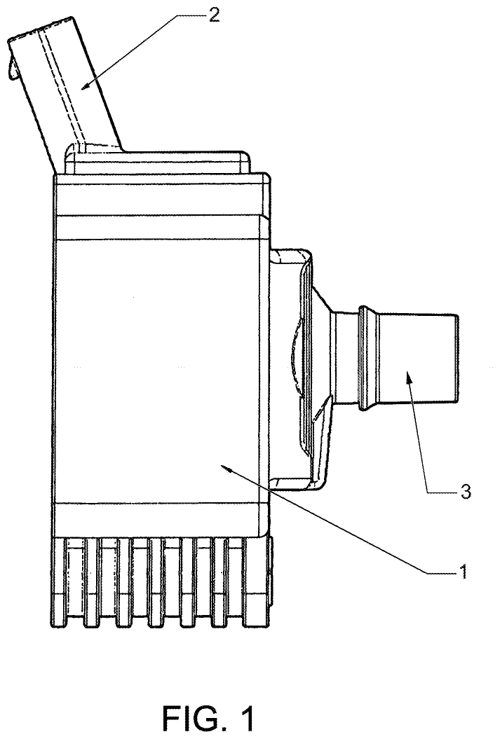

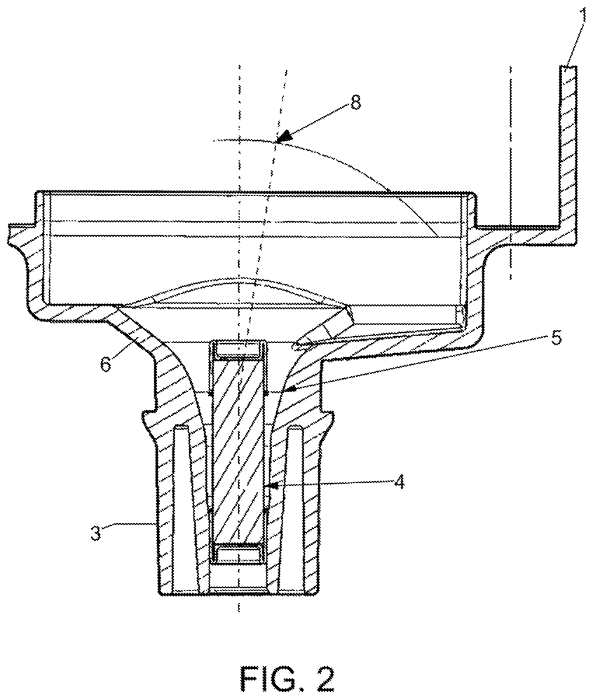

The ignition coil shown in FIG. 1 comprises a housing 1, which forms a first connection plug 2 for connecting to a power source, for example, the on-board network of a vehicle, and has a tubular housing part 3, which forms a second connection plug 3 for connecting to a spark plug. FIG. 2 shows a schematic sectional view of the ignition coil in the area of tubular housing part 3.

As FIG. 2 shows, an interference suppression resistor 4 is arranged in tubular housing part 3. This interference suppression resistor 4 is electrically connected to a transformer arranged in housing 1, which is not depicted in FIG. 2 for reasons of simplicity. As FIG. 2 shows, the interior, surrounded by housing 1, has a funnel-shaped section 5, which tapers towards tubular housing part 3. Housing 1 may, for example, be designed as a housing cup which is closed by a cover.

To assemble the ignition coil, interference suppression resistor 4 is dropped into housing 1. Funnel-shaped interior section 5 then causes interference suppression resistor 4 to arrive into tubular housing part 3 under the influence of gravity. Interference suppression resistor 4 may then be pressed into tubular housing part 3 without complex alignment in another assembly step. Interference suppression resistor 4 is then securely held in tubular housing part 3. Subsequently, a transformer is inserted into housing 1 and connected to interference suppression resistor 4. Afterwards, the housing cup may be filled with electrically-insulating sealing compound.

Funnel-shaped interior section 5 may, for example, have the shape of a truncated cone. In the embodiment shown, the funnel formed by the funnel-shaped interior section has an opening angle shown at reference numeral 8 whose value decreases toward the tubular section. In other words, the funnel is thus steepest at its end facing interference suppression resistor 4 and becomes increasing flatter toward its opposite end. In this way, funnel-shaped interior section 4 may be designed advantageously flat and thus compact, and still reliably guide an interference suppression resistor 4, inserted into the housing cup, into tubular housing part 3 during the assembly.

Funnel-shaped interior section 5 may extend, as depicted for example in FIG. 2, up into tubular housing part 3. However, it is preferred that funnel-shaped interior section 5 is not arranged completely in tubular housing part 3, but instead also extends into adjacent housing part 6. Housing part 6, adjacent to tubular housing part 3 and in which a part of funnel-shaped interior section 5 is arranged, may taper at its outer side toward tubular housing part 3. For example, it may also be funnel-shaped on its outer side.

Funnel-shaped interior section 5 may have a width at its end facing away from tubular housing part 3 which is at least four-fifths the length of interference suppression resistor 4, preferably at least as great as the length of interference suppression resistor 4. In this way, interference suppression resistor 4 is particularly reliably guided into tubular housing section 3 during assembly.

Tubular housing part 3 may be designed as a double-walled housing part. In this way, the pressing of interference suppression resistor 4 may be facilitated and its electrical insulation may be improved.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE NUMERALS

1 Housing
2 Connection plug
3 Tubular housing part
4 Interference suppression resistor
5 Funnel-shaped section
6 Housing part

What is claimed is:

1. An ignition coil, comprising:
a housing having a tubular housing part configured to connect to a spark plug;
a pin-shaped interference suppression resistor arranged in the tubular housing part; and
a funnel-shaped section in the housing that tapers toward the tubular housing part.

2. The ignition coil according to claim 1, wherein a part of the funnel-shaped section is arranged in the tubular housing part.

3. The ignition coil according to claim 1, wherein a part of the funnel-shaped section is arranged in a second housing part connected to the tubular housing part.

4. The ignition coil according to claim 3, wherein the second housing part tapers at an outer side thereof toward the tubular housing part.

5. The ignition coil according to claim 1, wherein the funnel-shaped section contacts an interior section in which a transformer is arranged.

6. The ignition coil according to claim 1, wherein the interference suppression resistor is pressed into the tubular housing part.

7. The ignition coil according to claim 1, wherein the funnel-shaped section has a width at an end facing away from the tubular housing part that is at least four-fifths the length of the interference suppression resistor.

8. The ignition coil according to claim 7, wherein the width is at least as great as the length of the interference suppression resistor.

9. The ignition coil according to claim 1, wherein the tubular housing part is a double-walled housing part.

10. The ignition coil according to claim 1, wherein the funnel-shaped interior section has an opening angle whose value decreases toward the interference suppression resistor.

11. A method for producing an ignition coil, comprising:
producing a housing cup having a tubular housing part at a bottom end and surrounding a funnel-shaped interior section;
using the funnel-shaped interior section to guide an interference suppression resistor into the tubular housing part;
connecting a transformer to the interference suppression resistor; and
pouring electrically-insulating sealing compound into the housing cup.

12. An ignition coil, comprising:
a housing having a tubular housing part configured to connect to a spark plug;
a pin-shaped interference suppression resistor arranged in the tubular housing part; and
a funnel-shaped section in the housing that tapers toward the tubular housing part, wherein the funnel-shaped section has an opening angle whose value decreases toward the interference suppression resistor.
